(19) United States
(12) Patent Application Publication
(10) Pub. No.: US 2017/0372379 A1
(43) Pub. Date: Dec. 28, 2017

(54) ADVERTISEMENT BIDDING APPARATUS AND ADVERTISEMENT PLATFORM APPARATUS

(71) Applicant: SK Planet Co., Ltd., Gyeonggi-do (KR)

(72) Inventor: Sang Mok SOHN, Gyeonggi-do (KR)

(73) Assignee: SK Planet Co., Ltd., Gyeonggi-do (KR)

(21) Appl. No.: 15/322,677

(22) PCT Filed: Dec. 1, 2015
(86) PCT No.: PCT/KR2015/012978

§ 371 Date: Dec. 28, 2016

(30) Foreign Application Priority Data
Mar. 18, 2015 (KR) 10-2015-0037277
Mar. 26, 2015 (KR) 10-2015-0042416
Jun. 19, 2015 (KR) 10-2015-0087206

(51) Int. Cl. G06Q 30/02

(52) U.S. Cl. CPC G06Q 30/0275; G06Q 30/0246

(57) ABSTRACT

The present disclosure proposes an advertisement bidding device capable of inducing advertisers to actively participate in bidding by determining a trustee group that guarantees an advertising effect among recipients receiving an advertisement and providing information related to the trustee group to the advertisers as bidding information.

### TECHNICAL FIELD

The present disclosure relates to a method for determining a trustee group to which an advertisement effect is guaranteed among recipients which receive an advertisement and providing information on trustee groups to advertisers as bidding information.

Also, the present disclosure relates to a method for predicting a selection frequency (for example, click to ratio (CTR)) of an advertisement for a user and providing predicted results to advertisers as bidding information.

### BACKGROUND ART

As the application market for an advertising medium that runs on mobile devices such as smart phones and tablet pads is rapidly expanding, the related advertising market is rapidly expanding.

In this regard, a mobile device (hereinafter, referred to as a terminal device) receives and displays an advertisement provided from an advertisement platform device upon execution of an application or access to a service page (for example, a web page) as an advertisement medium.

Prior to this, advertisers may register their advertisements on an advertisement platform device operated by a specific advertising agency through bidding.

However, even though an advertisement platform device has won the bid to attract advertisers, if the advertising agency fails to guarantee for a desired advertisement effects on the registered advertisements to the advertisers, the agency would fall behind in competition to attract the advertisers.

Therefore, what is required is a method of advertising that is competitive for attracting advertisers among advertising agencies while achieving successful advertisement.

### DISCLOSURE

### Technical Problem

To address the above described problems, an object of the present disclosure is to induce advertisers to actively participate in bidding by determining a trustee group that guarantees an advertisement effect among recipients which received an advertisement and provide information related to the trustee group to the advertisers as bidding information.

Also, to address the above described problems, another object of the present disclosure is to predict a selection frequency (for example, click to ratio (CTR)) of an advertisement for a user and provide predicted results to advertisers as bidding information to encourage the advertisers to participate actively in bidding.

### Technical Solution

To attain the above described object, an advertisement bidding device according to one embodiment of the present disclosure includes a verifying unit configured to verify a first recipient group in which preference for an advertisement is equal to or greater than a threshold value and a second recipient group in which preference for the advertisement is equal to or less than the threshold value among recipients receiving the advertisement, an evaluating unit configured to evaluate reliability of the preference calculation criteria (for calculating the preference based on a reaction state of the advertisement in the first recipient group and the second recipient group, and a determining unit configured to determine the first recipient group as a trustee group receiving the advertisement when the reliability of the preference calculation criteria (is determined to be equal to or greater than a threshold value.

More specifically, the reaction state with respect to the advertisement is verified from a first selection ratio that is a ratio of the recipients which select the advertisement in the first recipient group and a second selection ratio that is a ratio of the recipients which select the advertisement in the second recipient group.

More specifically, the reliability of the preference calculation criteria is evaluated to be higher as the first selection ratio is greater than the second selection ratio.

More specifically, the reliability of the preference calculation criteria is evaluated to be higher as a difference between the number of recipients belonging to the first recipient group and the number of recipients belonging to the second recipient group is smaller.

More specifically, the advertisement bidding device further includes a changing unit configured to change the preference calculation criteria when the reliability of the preference calculation criteria is determined to be less than the threshold value.

To attain the above described object, an advertisement bidding device according to one embodiment of the present disclosure includes an evaluating unit configured to evaluate a similarity between a first advertisement having an advertisement selection ratio equal to or higher than a threshold value among a plurality of advertisements received in a specific recipient group and a second advertisement being one of the remaining advertisements excluding the first advertisement, a calculating unit configured to calculate a prediction advertisement selection ratio with respect to the second advertisement based on the similarity evaluated for the second advertisement and the advertisement selection ratio of the second advertisement, and a determining unit configured to determine the specific recipient group as the trustee group with respect to the second advertisement when the prediction advertisement selection ratio with respect to the second advertisement is equal to or greater than a threshold value.

More specifically, the similarity is evaluated based on a ratio of the recipients which select both the first advertisement and the second advertisement in the specific recipient group.

More specifically, the evaluating unit evaluates the similarity to be higher as the ratio of recipients which select both the first advertisement and the second advertisement in the specific recipient group increases.

More specifically, the advertisement selection ratio is a ratio between the number of times of reception of the advertisement that is received in the particular recipient group and the number of times of selection of the advertisement in the particular recipient group during a specific time period.

More specifically, the prediction advertisement selection ratio is determined as multiplication between the similarity determined for the second advertisement and the advertisement selection ratio of the second advertisement within the advertisement selection ratio of the second advertisement.

To attain the above described object, an advertisement platform device according to one embodiment of the present disclosure includes a determining unit configured to determine log information which has a correlation with the number of times of selection of an advertisement among the log information received from a user in association with the advertisement as prediction log information for predicting the number of times of selection of other advertisements classified as the same advertisement classification item as the advertisement, a classifying unit configured to classify the prediction log information into a first prediction log information having an attribute mapped to a numerical value and a second prediction log information having an attribute not mapped to the numerical value, and a predicting unit configured to map a specific value to the second predication log information and predict the number of times of selection of the other advertisements with respect to a user based on the numerical value mapped to the first prediction log information and a specific value mapped to the second prediction log information.

More specifically, the specific value is mapped to the second prediction log information based on log information related to at least a portion of advertisements of which the second predication log information has the same attribute values among a plurality of advertisements when log information related to the plurality of advertisements are received from the user.

More specifically, the specific value is mapped to the second prediction log information as an average value of the numerical values mapped to the first predication log information existing in log information related to the at least a portion of advertisements.

More specifically, the specific value is mapped to the second prediction log information as an average value of the numerical values mapped to first specific prediction log information in which a magnitude of a correlation is equal to or greater than a threshold value among the first prediction log information equal to or greater than 2 when the first prediction log information is equal to or greater than 2.

More specifically, the number of times of selection of the other advertisements is predicted as result values by applying the magnitude of the correlation to the numerical values mapped to the first prediction log information and the specific values mapped to the second predication log information as a weight.

### Advantageous Effects

Therefore, in accordance with an advertisement bidding device of the present disclosure, a trustee group, which guarantees an advertisement effect among the recipients which received an advertisement, is determined and information related to the trustee group is provided to advertisers as bidding information so that it may be expected that the advertisers participate actively in bidding.

Also, in accordance with an advertisement platform device of the present disclosure, a selection frequency (for example, click to ratio (CTR)) of an advertisement for a user is predicted and predicted results are provide to advertisers as bidding information to encourage the advertisers to participate actively in bidding.

### DESCRIPTION OF DRAWINGS

FIG. 1 is a schematic configuration diagram of an advertisement providing system according to a first embodiment of the present disclosure.

FIG. 2 is a schematic configuration diagram of an advertisement bidding device according to the first embodiment of the present disclosure.

FIGS. 3 and 4 are diagrams for describing a recipient group according to the first embodiment of the present disclosure.

FIG. 5 is a schematic configuration diagram of a hardware system for implementing the advertisement bidding device according to the first embodiment of the present disclosure.

FIG. 6 is a flow chart for describing an operation flow in the advertisement bidding device according to the first embodiment of the present disclosure.

FIG. 7 is a schematic configuration diagram of an advertisement providing system according to a second embodiment of the present disclosure.

FIG. 8 is a schematic configuration diagram of an advertisement bidding device according to the second embodiment of the present disclosure.

FIG. 9 is a flow chart for describing an operation flow in the advertisement bidding device according to the second embodiment of the present disclosure.

FIG. 10 is a schematic configuration diagram of an advertisement providing system according to a third embodiment of the present disclosure.

FIG. 11 is a schematic configuration diagram of an advertisement platform device according to the third embodiment of the present disclosure.

FIG. 12 is a schematic configuration diagram of a hardware system for implementing an advertisement platform device according to the third embodiment of the present disclosure.

FIG. 14 is a flow chart for describing an operation flow in the advertisement platform device according to a third embodiment of the present disclosure.

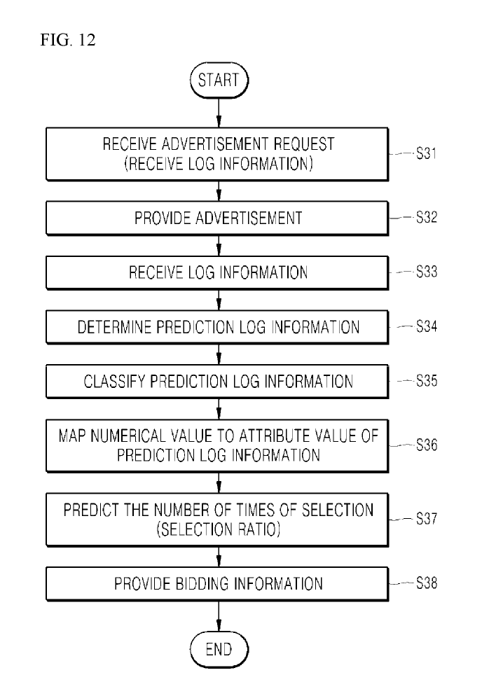

### BEST MODE

It is noted that the technical terms used herein are used only to describe specific embodiments and are not intended to limit the scope of the teachings disclosed herein. Also, the technical terms used herein should be interpreted in a sense that is generally understood by a person having ordinary skill in the art to which the presently disclosed technology belongs, unless the context clearly dictates otherwise and should not be construed in a broader sense or in an oversimplified sense. In addition, where technical terms used herein are inappropriate to exactly express the technical idea disclosed herein, they should be replaced with technical terms that allow the person in the art to properly understand. Also, the general terms used in the present disclosure should be interpreted in accordance with definitions in the dictionary and the predefined or prior context, and should not be construed as being excessively reduced in meaning.

As used herein, the singular form of “a,” “an,” and “the” include plural references unless the context clearly dictates otherwise. As used herein, the terms “consisting of,” “comprising,” etc., should not be construed as necessarily including all of the elements or steps listed thereafter, but some of the elements or steps may be omitted or additional elements or steps may further be included.

Furthermore, the terms first, second and the like in the description and in the claims are used for distinguishing between similar elements and not necessarily for describing a sequential or chronological order. The terms are used only for distinguishing one component from another component. The terms so used are interchangeable under appropriate circumstances, for example, a first component may be referred to as a second component and vice versa without departing from the scope of the present disclosure.

In the following detailed description, exemplary embodiments of the present disclosure will be described in detail with reference to the accompanying drawings. Throughout the drawings, like elements will be denoted by the same reference numerals and redundant descriptions will be omitted.

Detailed descriptions of well-known functions and structures incorporated herein will be omitted to avoid obscuring the gist of the technology disclosed herein. In addition, it is to be noted that the accompanying drawings are provided merely to facilitate understanding of the technical idea disclosed herein and that the scope of the technical idea is not limited thereby.

Hereinafter, a first embodiment of the present disclosure will be described with reference to the accompanying drawings.

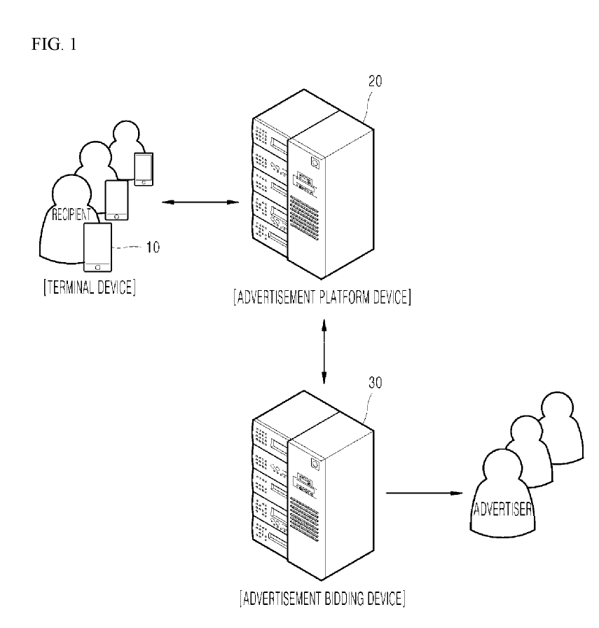

FIG. 1 is a diagram illustrating an advertisement bidding system according to the first embodiment of the present disclosure.

As shown in FIG. 1, the advertisement bidding system according to the first embodiment of the present disclosure has configuration including a terminal device 10 for receiving an advertisement, an advertisement platform device 20 for providing the advertisement for the terminal device 10, and an advertisement bidding device 30 for providing advertisers with bidding information.

Also, the advertisement providing system according to the first embodiment of the present disclosure may also have a configuration that further includes a service device (not shown) that provides a service page (for example, a web page) related to the advertisement in addition to the above described configuration.

The terminal device 10 refers to a mobile device capable of receiving the advertisement through an advertisement medium and performing a series of operations such as accessing a service page related to the advertisement.

For example, the terminal device 10 may be a smart phone, a tablet PC, a PDA, and the like, and is capable of receiving an advertisement through the advertisement medium, which is not limited thereto, and all devices capable of running a browser for connecting to a service page (for example, web page).

Here, the advertisement medium, which enables advertisement reception in the terminal device 10, may be, for example, an application executed in the terminal device 10 itself or a service page in which the terminal device 10 may access the browser by calling the browser.

In such an advertisement medium, a software development kit (SDK) related to receiving advertisements is included in the development process. As a result, the terminal device 10 performs a series of operations for requesting, receiving, and displaying the advertisements through the SDK included in the advertisement medium.

In addition, the advertisement medium may support a collection function for advertisement history information, as well as the above described series of functions related to the advertisement request, reception and display.

For example, when the terminal device 10 receives, displays, and selects (that is, clicks) an advertisement in an application or a service page, it may collect advertisement information as the advertisement history information and transmit the advertisement history information to the advertisement platform device 20.

In the terminal device 10 according to the first embodiment of the present disclosure, an advertisement is received through a pull method, which is a method of requesting and receiving the advertisement to the advertisement platform device 20 using terminal identification information issued to the terminal device 10

However, the advertisement is not limited to the above described advertisement receiving method and it may also be possible by a push method in which an advertisement provided by the advertisement platform device 20 is received without a separate advertisement request for the advertisement platform device 20.

The advertisement platform device 20 refers to an advertisement server that provides advertisements to the terminal device 10.

The advertisement platform device 20 provides advertisements registered from advertisers to the terminal device 10 according to an advertisement request received from the terminal device 10.

For reference, the advertisement platform device 20 may classify users having the terminal device 10 into a plurality of recipient groups according to their characteristics (for example, sex, age, residence, interest, and the like), and selectively provide suitable advertisements for each of the recipient groups.

In addition, the advertisement platform device 20 collects advertisement history information (for example, an advertisement reception, an advertisement display, an advertisement selection, and the like) from the terminal device 10 receiving advertisements and various information (for example, residence, age, product purchase information, and the like) with respect to users possessing the terminal device 10.

The advertisement bidding device 30 refers to a server for selecting an advertiser which may register an advertisement on the advertisement platform device 20.

In the advertisement bidding device 30, an advertiser for registering advertisements on the advertisement platform device 20 among a plurality of advertisers participating in bidding is selected through a bidding method.

In the above description, the advertisement platform device 20 and the advertisement bidding device 30 are independently implemented from each other, but they are not limited thereto, and they may also be combined into one configuration.

Meanwhile, in one embodiment of the present disclosure, as described above, a method of selecting an advertiser for registering an advertisement on the advertisement platform device 20 follows the bidding method.

Competition for attracting advertisers to other advertising agencies is inevitable in the bidding method.

In order to gain a competitive advantage in attracting advertisers, it is necessary for advertisers to be able to guarantee a desired advertising effect, and it is necessary to provide bidding information related to guarantee of advertising effect to advertisers participating in the bidding.

Accordingly, in one embodiment of the present disclosure, a method for determining a trustee group that guarantees an advertising effect among recipients which receive an advertisement, and providing information with respect to the trustee group to advertisers as bidding information is proposed. The advertisement bidding device 30 for implementing the method will be described in detail below.

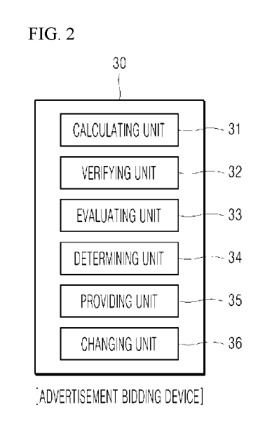

FIG. 2 shows a configuration of the advertisement bidding device 30 according to the first embodiment of the present disclosure.

As shown in FIG. 2, the advertisement bidding device 30 according to the first embodiment of the present disclosure has a configuration including a calculating unit 31 for calculating a preference, a verifying unit 32 for verifying a recipient group, an evaluating unit 33 for evaluating reliability of a preference calculating criteria, a determining unit 34 for determining a trust preference target, a providing unit 35 for providing bidding information, and a changing unit 36 for changing the preference calculating criteria.

All or at least a portion of the advertisement bidding device 30 including the calculating unit 31, the verifying unit 32, the evaluating unit 33, the determining unit 34, the providing unit 35, and the changing unit 36 as described above may be implemented in the form of a software module executed by a processor, a hardware module, or a combination thereof.

As a result, the advertisement bidding device 30 according to the first embodiment of the present disclosure determines a trustee group that guarantees the advertising effect among recipients which receive advertisements through the above described configurations, and provides the determined information to advertisers as bidding information, and each configuration of the advertisement platform device 20 for implementing the determination and provision will be described in detail below.

The calculating unit 31 serves to calculate preference of each recipient with respect to an advertisement.

More specifically, the calculating unit 31 calculates preference for an advertisement for each recipient receiving the advertisement.

At this time, the calculating unit 31 may calculate the preference for the advertisement per recipient using a predefined preference calculation criteria(.

The preference calculation criteria may be defined using information collected by the advertisement platform device 20, that is, advertisement history information (for example, an advertisement reception, an advertisement display, an advertisement selection, and the like), and various information (for example, residence, age, product purchase information, and the like) with respect to users possessing the terminal device 10.

Here, the preference calculation criteria may be defined through a method of differently combining information collected by the advertisement platform device 20 as a calculation criteria according to an advertisement purpose as intended by the advertiser, for example, an increase in sales, an increase in brand image, and the like.

For example, if the advertisement purpose is an increase in sales, the preference calculation criteria may be defined as the following Equation 1.

Preference=[advertisement selection×α(weight)]+[advertisement related purchase information×β(weight)+[recipient residence×γ(weight)] [Equation 1]

The verifying unit 32 serves to verify the recipient group.

More specifically, the verifying unit 32 verifies the recipient group according to a size of the calculated preference when the preference calculation for the advertisement per recipient is completed.

At this time, the verifying unit 32 verifies a first recipient group in which preference for the advertisement is equal to or greater than a threshold value among the recipients receiving the advertisement, whereas it verifies a second recipient group in which preference for the advertisement is less than the threshold value.

Here, the preferences for advertisements per recipient calculated through the calculating unit 31 may be rearranged according to priorities based on the advertisement as shown in Table 1.

TABLE 1

| | | recipient ID | recipient ID | | |
|---|---|---|---|---|---|
| | recipient ID | (preference | (preference | | |
| | (preference | equal to or | equal to or | | |
| | equal to or | greater than | greater than | | |
| advertisement | greater than | 4.0 and less | 3.5 and less | | |
| ID | 4.5) | than 4.5) | than 4.0) | . . . | . . . |
| T1 | 1, 2, . . . | . . . | . . . | . . . | . . . |

As a result, the verifying unit 32 may verify the recipients in which preferences for the advertisements are equal to or greater than the threshold value as the first recipient group, through a process of rearranging the preferences of the recipients calculated with respect to the advertisements in the order of priority as shown in Table 1, and otherwise, it may verify the recipients in which preferences are less than the threshold value as the second recipient group.

For reference, the threshold values of preference used to verify the first and second recipient groups may be assigned the same value or different values.

The evaluating unit 33 serves to evaluate reliability of the preference calculation criteria used to calculate the preference.

More specifically, the evaluating unit 33 evaluates the reliability of the preference calculation criteria based on a reaction state with respect to the advertisement in each recipient group when the first and second recipient groups are verified.

Here, the reaction state with respect to the advertisement in the first recipient group and the second recipient group may be verified through a method of comparing how much a selection of the advertisement is made in each recipient group.

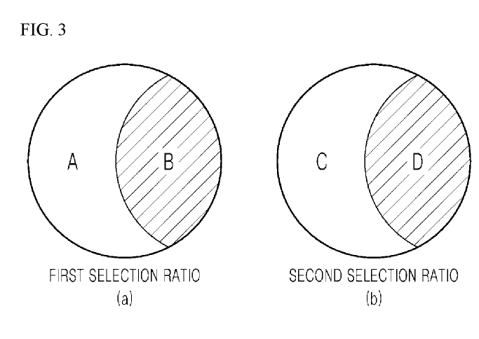

The evaluating unit 33 evaluates the reaction state with respect to the advertisement in the first and second recipient groups by comparing a first selection ratio, as shown in (a) of FIG. 3, which is a ratio of a recipient (A) selecting the advertisement in the first recipient group (A+B) with a second selection ratio, as shown in (b) of FIG. 3, which is a ratio of a recipient (C) selecting the advertisement in the second recipient group (C+D).

As a result, the evaluating unit 33 evaluates that the reliability of the preference calculation criteria used for calculating the preference of each recipient is higher as the first selection ratio is greater than the second selection ratio, and otherwise, it evaluates that the reliability of the preference calculation criteria used for calculating the preference of each recipient is lower as the second selection ratio is greater than the first selection ratio.

In this case, when the preference for the advertisement is high, an actual reaction state for the advertisement may be expected to be high, and otherwise, when the preference for the advertisement is low, the actual reaction state for the advertisement may also be expected to be low.

The result that the first selection ratio is greater than the second selection ratio means that the actual reaction state in the first recipient group calculated as having the higher preference with respect to the advertisement is better than the actual reaction state in the second recipient group calculated as having the lower preference with respect to the advertisement so that the reliability of the preference calculation criteria used to calculate the preference may be evaluated to be higher.

Contrary to the above expectations, the result that the second selection ratio is greater than the first selection ratio means that the actual reaction state in the second recipient group calculated as having the higher preference with respect to the advertisement is better than the actual reaction state in the first recipient group calculated as having the lower preference with respect to the advertisement so that the reliability of the preference calculation criteria used to calculate the preference may be evaluated to be lower.

Meanwhile, as shown in FIG. 4, it may be assumed that the number of recipients belonging to the second recipient group is much greater than the number of recipients belonging to the first recipient group. In this case, the reliability evaluated by comparing the first selection ratio with the second selection ratio may not be an accurate evaluation result.

In order to consider such a case, it should be a premise that the smaller a difference between the number of recipients belonging to the first recipient group and the number of recipients belonging to the second recipient group, the higher the reliability of the preference calculation criteria, and contrarily, the higher a difference between the number of recipients belonging to the first recipient group and the number of recipients belonging to the second recipient group, the lower the reliability of the preference calculation criteria.

The determining unit 34 serves to determine a trustee group.

More specifically, the determining unit 34 determines the trustee group that guarantees the advertising effect according to the reliability determination result of the preference calculation criteria.

At this time, when the determined reliability with respect to the preference calculation criteria is equal to or greater than the threshold value, the determining unit 34 determines the first recipient group, which has been verified to have a high preference for the advertisement, as the trustee group for which the advertising effect is guaranteed.

The providing unit 35 serves to provide the bidding information.

More specifically, when the trustee group is determined, the providing unit 35 may provide advertisers with information on the determined trustee group as the bidding information, thereby inducing advertisers to actively participate in bidding.

For reference, as the trustee group that guarantees the advertising effect is determined through the calculation of the preference using the preference calculation criteria and the process of verifying the reliability of the preference calculation criteria, it may set a high advertisement ratio for an opportunity of providing advertisements with respect to the trustee group.

The changing unit 36 serves to change the preference calculation criteria.

More specifically, when the reliability of the preference calculation criteria is determined to be less than the threshold value, the changing unit 36 changes the predefined preference calculation criteria and transmits the changed preference calculation criteria to the calculating unit 31 such that the preference calculation process and the reliability evaluation process, which use the changed preference calculation criteria, may be repeated.

In the above described advertisement bidding device 30, it has been mentioned that a software module or a hardware module executed by a processor, or a combination thereof may be implemented.

As such, the software module executed by a processor, the hardware module, or a combination thereof may be implemented in a hardware system (for example, a computer system).

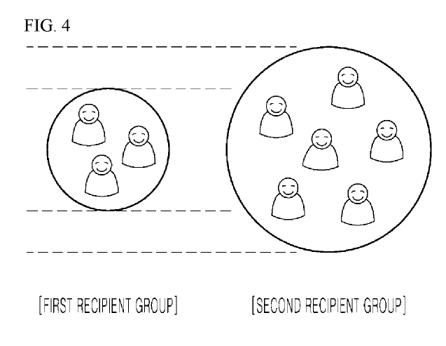

Therefore, a hardware system 100 for implementing the advertisement bidding device 30 according to the first embodiment of the present disclosure will be described below with reference to FIG. 5.

For reference, the following description is an example for implementing each configuration in the above described advertisement bidding device 30 in the hardware system 100, and each configuration and an operation thereof may also be different from an actual system.

FIG. 5 shows a structure of the hardware system 100 for implementing the advertisement bidding device 30 according to the first embodiment of the present disclosure.

As shown in FIG. 5, the hardware system 100 for implementing the advertisement platform device 20 according to the first embodiment of the present disclosure may have a configuration including a processor 110, a memory interface 120, and a peripheral interface 130.

Each configuration of such a hardware system 100 may be an individual component or may be integrated on one or more integrated circuits, and it may be coupled to a bus system (not shown).

Here, the bus system is one or more arbitrary individual physical buses connected by appropriate bridges, adapters, and/or controller, communication lines, communication interfaces, and/or multi-drop buses, or an abstraction representing point-to-point connections.

The processor 110 serves to execute various software modules stored in a memory 121 so as to perform various function in the hardware system 100 by communicating with the memory 121 through the memory interface 120.

Here, the calculating unit 31, the verifying unit 32, the evaluating unit 33, the determining unit 34, the providing unit 35, and the changing unit 36, each of which is the configuration in the advertisement bidding device 30 described above with reference to FIG. 2, are stored in the memory 121 in the form of a software module, and other operating systems may be additionally stored in the memory 121.

The above described operation system (for example, an embedded operating system such as iOS, Android, Darwin, RTXC, LINUX, UNIX, OS X, WINDOWS, or VxWorks) includes various procedures, command sets, software components and/or drivers for controlling and managing general system works (for example, a memory management, a storage device management, a power management, and the like), and serves to facilitate communications between various hardware modules and various software modules.

For reference, the memory 121 includes a cache, a main memory, and a secondary memory, but it is not limited thereto, and may include a memory hierarchy structure. The memory hierarchy structure may be implemented through an arbitrary combination of a random-access memory (RAM) (for example, a static RAM (SRAM), a dynamic RAM (DRAM), and a display data RAM (DDRAM)), a read-only memory (ROM), a flash memory, and a magnetic and/or optical storage device (for example, a disc drive, a magnetic tape, a compact disk (CD), a digital video disc (DVD), and the like).

The peripheral interface 130 serves to enable a communication between the processor 110 and the peripherals.

The peripherals provide different functions to a computer system, and may include, for example, a communication device 131 in one embodiment of the present disclosure.

Here, the communication device 131 serves to provide a communication function with other devices. For this purpose, the communication device 131 includes, for example, an antenna system, a radio frequency (RF) transceiver, one or more amplifiers, a tuner, one or more oscillators, a digital signal processor, a codec chipset, a memory, and the like, but it is not limited thereto, and it may include a known circuit performing the communication function.

A protocol supported by such a communication device 131 corresponds to a protocol for a long term evolution (LTE), a time division multiple access (TDMA), a code division multiple access (CDMA), a global system for mobile communications (GSM), an enhanced data GSM environment (EDGE), a wideband code division multiple access (W-CDMA), a Wi-Fi (IEEE 802.11a, IEEE 802.11b, IEEE 802.11g, IEEE 802.11n, and/or the like), Bluetooth, a Wi-MAX, a voice over internet protocol (VoIP), an e-mail, an instant messaging, and an SMS, but it is not limited thereto, and it may include all protocols providing a communication environment with other devices.

Therefore, each configuration in the advertisement bidding device 30, which is stored in the memory 121 in the form of the software module, may perform a communication with the communication device 131 by the medium of the memory interface 120 and the peripheral interface 130 when each configuration is executed by the processor 110, thereby providing information with respect to the trustee group that is guaranteed the advertising effect as the bidding information.

Hereinafter, with reference to FIG. 5, the configuration of the hardware system 100 for implementing the advertisement bidding device 30 will be described in detail

For convenience of a description, it is assumed that each configuration in the advertisement bidding device 30 stored in the memory 121 in the form of a software module is executed by the processor 110.

The calculating unit 31 serves to calculate the preference of the advertisement per recipient.

More specifically, the calculating unit 31 calculates the preference for the advertisement using the predefined preference calculation criteria with respect to each recipient receiving the advertisement, and transmits the result of the preference calculation to the verifying unit 32.

The verifying unit 32 serves to verify the recipient group.

More specifically, when receiving the result of the preference calculation with respect to the advertisement per recipient, the verifying unit 32 verifies the recipient group according to a size of the calculated preference, and transmits the verification result to the evaluating unit 33.

At this point, the verifying unit 32 verifies the first recipient group in which preference with respect to the advertisement is equal to or greater than the threshold value among the recipients receiving the advertisement, and otherwise, it verifies the second recipient group in which preference with respect to the advertisement is less than the threshold value.

The evaluating unit 33 serves to evaluate the reliability of the preference calculation criteria used to calculate the preference.

More specifically, when receiving the recipient group verification result, the evaluating unit 33 evaluates the reliability of the preference calculation criteria based on the reaction state with respect to the advertisement in the first and second recipient groups, and transmits the evaluation result to the determining unit 34.

The evaluating unit 33 evaluates the reaction state with respect to the advertisement in the first and second recipient groups by comparing a first selection ratio, as shown in (a) of FIG. 3, which is a ratio of a recipient (A) selecting the advertisement in the first recipient group (A+B) with a second selection ratio, as shown in (b) of FIG. 3, which is a ratio of a recipient (C) selecting the advertisement in the second recipient group (C+D).

As a result, the evaluating unit 33 evaluates that the reliability of the preference calculation criteria used for calculating the preference of each recipient is higher as the first selection ratio is greater than the second selection ratio, and otherwise, it evaluates that the reliability of the preference calculation criteria used for calculating the preference of each recipient is lower as the second selection ratio is greater than the first selection ratio.

The determining unit 34 serves to determine the trustee group.

More specifically, the determining unit 34 determines the trustee group that guarantees an advertising effect according to the reliability determination result of the preference calculation criteria, and transmits information with respect to the determined trustee group to the providing unit 35.

At this point, when the determined reliability for the preference calculation criteria is equal to or greater than the threshold value, the determining unit 34 determines the first recipient group, which has been confirmed to have a high preference for the advertisement, as the trustee group for which the advertising effect is guaranteed.

The providing unit 35 serves to provide the bidding information through the communication device 131.

More specifically, when the information with respect to the trustee group is received, the providing unit 35 may provide the communication device 131 with information with respect to the trustee group to the advertisers as the bidding information, thereby inducing the advertisers to actively participate in the bidding.

The changing unit 36 serves to change the preference calculation criteria.

More specifically, when the reliability of the preference calculation criteria is determined to be less than the threshold value, the changing unit 36 receives the reliability determination result from the determining unit 34 and changes the predefined preference calculation criteria.

In addition, the changing unit 36 transmits the changed preference calculation criteria to the calculating unit 31 such that the preference calculation process and the reliability evaluation process, which use the changed preference calculation criteria, may be repeated.

As described above, in accordance with the advertisement bidding device 30 according to the first embodiment of the present disclosure and the hardware system 100 for implementing the advertisement bidding device 30, the trustee group that guarantees the advertising effect among the recipients receiving the advertisement is determined, and then is provided to the advertisers as bidding information, it may expect that the advertisers actively participates in the bidding.

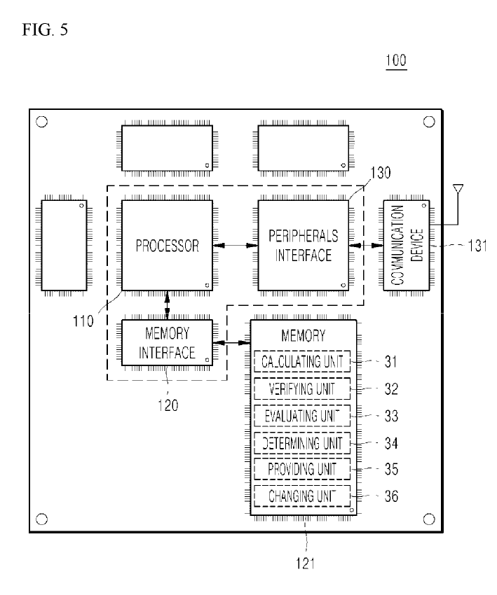

Hereinafter, an operation flow in the advertisement bidding device 30 according to the first embodiment of the present disclosure will be described with reference to FIG. 6. For convenience of a description, the above described configurations shown in FIGS. 1 to 5 are described by referring to corresponding reference numbers.

Firstly, the calculating unit 31 calculates a preference with respect to an advertisement for each of recipients receiving the advertisement in Operation S11.

At this point, the calculating unit 31 may calculate the preference for the advertisement per recipient using the predefined preference calculation criteria.

The preference calculation criteria may be defined using information collected by the advertisement platform device 20, that is, advertisement history information (for example, an advertisement reception, an advertisement display, an advertisement selection, and the like), and various information (for example, residence, age, product purchase information, and the like) with respect to users possessing the terminal device 10.

Here, the preference calculation criteria may be defined through a method of differently combining information collected by the advertisement platform device 20 as a calculation criteria according to an advertisement purpose as intended by the advertiser, for example, an increase in sales, an increase in brand image, and the like.

Then, the verifying unit 32 verifies a recipient group according to a size of the calculated preference when the preference calculation with respect to the advertisement per recipient is completed in Operation S12.

At this point, the verifying unit 32 verifies the recipients in which preferences with respect to the advertisements are equal to or greater than the threshold value as a first recipient group, and otherwise, it verifies the recipients in which preferences with respect to the advertisements are less than the threshold value as the second recipient group.

Here, the preferences for advertisements per recipient calculated through the calculating unit 31 may be rearranged according to priorities based on the advertisement as shown in Table 1.

As a result, through rearrangement of the calculated preferences of the recipients according to a priority, the verifying unit 32 verifies the recipients in which preferences with respect to the advertisement are equal to or greater than the threshold value as the first recipient group, and otherwise, it verifies the recipients in which preferences with respect to the advertisement are less than the threshold value as the second recipient group

For reference, threshold values of preferences used to verify the first and second recipient groups may be assigned the same value or different values.

Thereafter, the evaluating unit 33 evaluates the reliability of the preference calculation criteria based on the reaction state of the advertisement in each recipient group, when the first recipient group and the second recipient group are verified in Operation S13.

At this point, the evaluating unit 33 evaluates the reaction state with respect to the advertisement in the first and second recipient groups by comparing a first selection ratio, as shown in (a) of FIG. 3, which is a ratio of a recipient (A) selecting the advertisement in the first recipient group (A+B) with a second selection ratio, as shown in (b) of FIG. 3, which is a ratio of a recipient (C) selecting the advertisement in the second recipient group (C+D).

As a result, the evaluating unit 33 evaluates that the reliability of the preference calculation criteria used for calculating the preference of each recipient is higher as the first selection ratio is greater than the second selection ratio, and otherwise, it evaluates that the reliability of the preference calculation criteria used for calculating the preference of each recipient is lower as the second selection ratio is greater than the first selection ratio.

Meanwhile, as shown in FIG. 4, it may be assumed that the number of recipients belonging to the second recipient group is much larger than the number of receivers belonging to the first recipient group. In this case, the reliability, which is evaluated through the comparison of the first selection ratio and the second selection ratio, may not be an accurate evaluation result.

In order to consider such a case, it should be a premise that the smaller a difference between the number of recipients belonging to the first recipient group and the number of recipients belonging to the second recipient group, the higher the reliability of the preference calculation criteria, and contrarily, the higher a difference between the number of recipients belonging to the first recipient group and the number of recipients belonging to the second recipient group, the lower the reliability of the preference calculation criteria.

Further, the determining unit 34 determines a trustee group in which the advertising effect is guaranteed according to the reliability determination result of the preference calculation criteria in Operations S14 and S15.

At this point, when the determined reliability for the preference calculation criteria is equal to or greater than the threshold value, the determining unit 34 determines the first recipient group, which has been verified to have a high preference for the advertisement, as the trustee group for which the advertising effect is guaranteed.

Afterward, when the trustee group is determined, the providing unit 35 provides the advertisers with information with respect to the determined trustee group as the bidding information, thereby inducing active participation of the advertisers in the bidding in Operation S16.

Meanwhile, when the reliability of the preference calculation criteria is determined to be less than the threshold value through Operations ‘S13’ and ‘S14,’ the changing unit 36 changes the predefined preference calculation criteria and transmits the changed preference calculation criteria to the calculating unit 31, thereby allowing a repetition the preference calculation process and the reliability determination process (S11 to S14) using the changed preference calculation criteria in Operation S17.

As described above, in accordance with the operation flow in the advertisement bidding device 30 according to the first embodiment of the present disclosure, the trustee group, which guarantees the advertising effect among the recipients which receive the advertisement, is determined to provide information with respect to the advertisement effect to the advertisers such that it may expect that the advertisers actively participates in the bidding.

Hereinafter, a second embodiment of the present disclosure will be described with reference to the accompanying drawings.

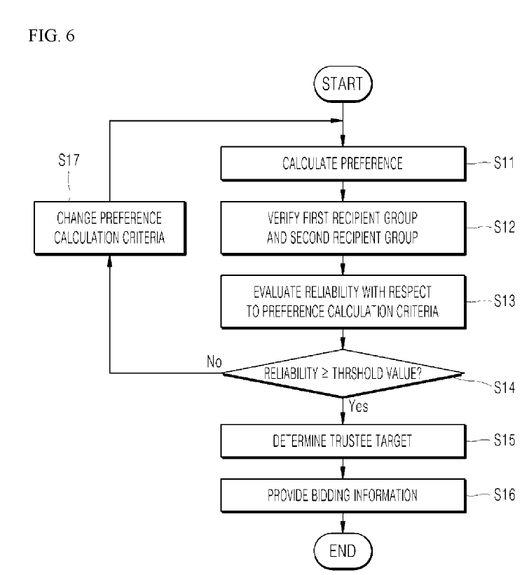

FIG. 7 is a diagram illustrating an advertisement bidding system according to the second embodiment of the present disclosure.

As shown in FIG. 7, the advertisement bidding system according to the second embodiment of the present disclosure has a configuration including a terminal device 40 for receiving an advertisement, an advertisement platform device 50 for providing the advertisement to the terminal device 40, and an advertisement bidding device 60 for providing advertisers with bidding information.

Also, an advertisement providing system according to the second embodiment of the present disclosure may also have a configuration that further includes a service device (not shown) that provides a service page (for example, a web page) related to the advertisement in addition to the above described configuration.

The terminal device 40 refers to a mobile device capable of receiving the advertisement through an advertisement medium and performing a series of operations such as accessing a service page related to the advertisement.

For example, the terminal device 40 may be a smart phone, a tablet PC, a PDA, and the like, and is capable of receiving an advertisement through the advertisement medium, which is not limited thereto, and all devices capable of running a browser for connecting to a service page (for example, a web page).

Here, the advertisement medium, which enables advertisement reception in the terminal device 40, may be, for example, an application executed in the terminal device 40 itself or a service page in which the terminal device 40 may access the browser by calling the browser.

In such an advertisement medium, a software development kit (SDK) related to receiving advertisements is included in the development process. As a result, the terminal device 40 performs a series of operations for requesting, receiving, and displaying the advertisements through the SDK included in the advertisement medium.

In addition, the advertisement medium may support a collection function for advertisement history information, as well as the above described series of functions related to the advertisement request, reception and display.

For example, when the terminal device 40 receives, displays, and selects (that is, clicks) an advertisement in an application or a service page, it may collect advertisement information as the advertisement history information and transmit the advertisement history information to the advertisement platform device 50.

Also, in the terminal device 40 according to the second embodiment of the present disclosure, an advertisement is received through a pull method, which is a method of requesting and receiving the advertisement to the advertisement platform device 50 using terminal identification information issued to the terminal device 40.

However, the advertisement is not limited to the above described advertisement receiving method and it may also be possible by a push method in which an advertisement provided by the advertisement platform device 50 is received without a separate advertisement request for the advertisement platform device 50.

The advertisement platform device 50 refers to an advertisement server that provides advertisements to the terminal device 40.

The advertisement platform device 50 provides advertisements registered from advertisers to the terminal device 40 according to an advertisement request received from the terminal device 40.

For reference, the advertisement platform device 50 may classify users having the terminal device 40 into a plurality of recipient groups according to their characteristics (for example, sex, age, residence, interest, and the like), and selectively provide suitable advertisements for each of the recipient groups.

In addition, the advertisement platform device 50 collects advertisement history information (for example, an advertisement reception, an advertisement display, an advertisement selection, and the like) from the terminal device 40 receiving advertisements and various information (for example, residence, age, product purchase information, and the like) with respect to users possessing the terminal device 40.

The advertisement bidding device 60 refers to a server for selecting an advertiser which may register an advertisement on the advertisement platform device 50.

In the advertisement bidding device 60, an advertiser for registering advertisements on the advertisement platform device 50 among a plurality of advertisers participating in bidding is selected through a bidding method.

In the above description, the advertisement platform device 50 and the advertisement bidding device 60 are independently implemented from each other, but they are not limited thereto, and they may also be combined into one configuration.

Meanwhile, in one embodiment of the present disclosure, as described above, a method of selecting an advertiser for registering an advertisement on the advertisement platform device 50 follows the bidding method.

Competition for attracting advertisers to other advertising agencies is inevitable in the bidding method.

In order to gain a competitive advantage in attracting advertisers, it is necessary for advertisers to be able to guarantee a desired advertising effect, and it is necessary to provide in advance bidding information related to guarantee of advertising effect to advertisers participating in the bidding.

Accordingly, in one embodiment of the present disclosure, a method for determining a trustee group that guarantees an advertising effect among recipients which receive an advertisement, and providing information with respect to the trustee group to advertisers as bidding information is proposed. The advertisement bidding device 60 for implementing the method will be described in detail below.

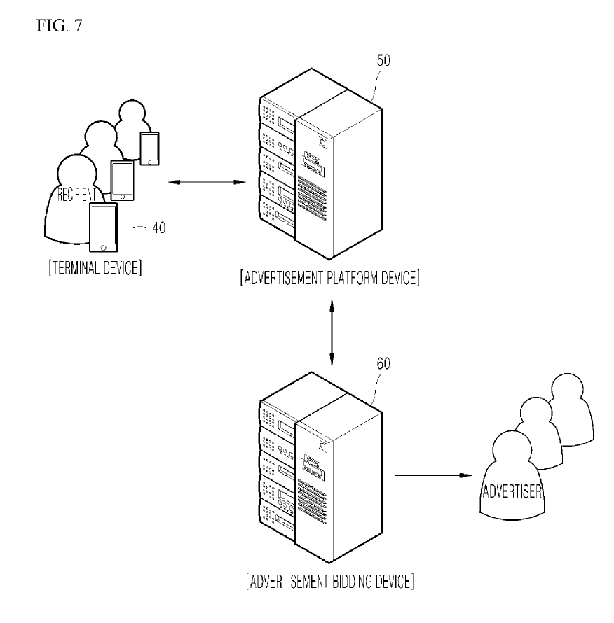

FIG. 8 shows a configuration of the advertisement bidding device 60 according to the second embodiment of the present disclosure.

As shown in FIG. 8, the advertisement bidding device 60 according to the second embodiment of the present disclosure has a configuration including a verifying unit 61 for verifying an advertisement selection ratio (for example, a click to ratio (CTR)), an evaluating unit 62 for evaluating a preference, a calculating unit 63 for calculating a prediction advertisement selection ratio, a determining unit 64 for determining a trustee group, and a providing unit 65 for providing bidding information.

All or at least a portion of the advertisement bidding device 60 including the verifying unit 61, the evaluating unit 62, the calculating unit 63, the determining unit 64, and the providing unit 65 as described above may be implemented in the form of a software module executed by a processor, a hardware module, or a combination thereof.

As a result, the advertisement bidding device 60 according to the second embodiment of the present disclosure determines a trustee group that guarantees the advertising effect among recipients which receive advertisements through the above described configurations, and provides the determined information to advertisers as bidding information, and each configuration of the advertisement bidding device 60 for implementing the determination and provision will be described in detail below.

The verifying unit 61 serves to verify the advertisement selection ratio.

More specifically, the verifying unit 61 verifies the advertisement selection ratio for each of a plurality of advertisements received in a specific recipient group.

Here, the advertisement selection ratio refers to a ratio between the number of times of reception of the advertisement that is received in the specific recipient group and the number of times of selection of the advertisement that is selected in the specific recipient group for each advertisement as in Equation 2.

Advertisement selection ratio=(the number of times of selection of advertisement/the number of times of reception of advertisement)×100 [Equation 2]

At this time, the verifying unit 61 verifies the advertisement selection ratio for a specific period with respect to each advertisement received from the specific recipient group, and the specific time period may correspond to a period (for example, one week and one day) until a specified period arrives, for example, to determine the trustee group.

For reference, a high advertisement selection ratio with respect to a specific advertisement may mean that the advertising effect is high in the specific recipient group, and contrarily, a low advertisement selection ratio may mean that the advertising effect is low in the particular recipient group.

The evaluating unit 62 serves to evaluate similarity between the advertisements.

More specifically, when the advertisement selection ratio with respect to each advertisement received in the specific recipient group is verified, the evaluating unit 62 evaluates similarity between advertisements (hereinafter referred to as ‘a first advertisement’) which are verified that the advertisement selection ratio is equal to or greater than the threshold value and the remaining advertisements (hereinafter, referred to as ‘second advertisement’) received in the specific recipient group except the first advertisement.

Here, the similarity between the first advertisement and the second advertisement may be evaluated through a method of verifying a recipient which selects the first advertisement and the second advertisement in the specific recipient group.

Accordingly, the evaluating unit 62 evaluates the similarity between the first advertisement and the second advertisement by checking a ratio of the recipients selecting both the first advertisement and the second advertisement in the specific recipient group as in Equation 3.

Recipient ratio (similarity)=(the number of recipients selecting both first advertisement and second advertisement/the number of times of reception of first advertisement and second advertisement)×100 [Equation 3]

For reference, it is assumed that the first advertisement and the second advertisement are all received in the specific recipient group. In the case of the number of recipients receiving the first advertisement and the second advertisement located in the denominator in Equation 3, it may correspond to the number of all recipients belonging to the specific recipient group.

At this point, the evaluating unit 62 evaluates that the similarity between the first advertisement and the second advertisement is high if the ratio of the recipients selecting both the first advertisement and the second advertisement increases, and contrarily, it evaluates that the similarity between the first advertisement and the second advertisement is low if the ratio of the recipients selecting both the first advertisement and the second advertisement decreases.

Here, the result that the ratio of the recipients selecting both the first advertisement and the second advertisement in the specific recipient group is large indicates that the recipient which selects the first advertisement selects the second advertisement and the recipient which receives the second advertisement also has a higher probability of selecting the first advertisement, so that the similarity between the first advertisement and the second advertisement is high.

The calculating unit 63 serves to calculate a prediction advertisement selection ratio.

More specifically, when the similarity determination between the first advertisement and the second advertisement is completed, the calculating unit 63 calculates the prediction advertisement selection ratio with respect to the second advertisement based on the similarity determined between the first advertisement and the second advertisement and the advertisement selection ratio substantially verified with respect to the second advertisement.

Here, the prediction advertisement selection ratio refers to an advertisement selection ratio predicted in the future (for example, a next cycle) with respect to the second advertisement, and it may be calculated by multiplying the verified similarity between the first advertisement and the second advertisement and the advertisement selection ratio substantially verified with respect to the second advertisement as in Equation 4.

Prediction advertisement selection ratio=similarity×advertisement selection ratio [Equation 4]

At this point, in calculating the prediction advertisement selection ratio for the second advertisement, the calculating unit 63 calculates a ratio that does not exceed the substantially verified advertisement selection ratio for the second advertisement, and for this, the similarity value verified for the first advertisement and the second advertisement is leveled to a value between 0 and 1, and then is multiplied by the advertisement selection ratio verified for the second advertisement.

The determining unit 64 performs a function of determining the trustee group.

More specifically, when the prediction advertisement selection ratio for the second advertisement is calculated, the determining unit 64 verifies whether the calculated prediction advertisement selection ratio is equal to or greater than a threshold value, and, when the calculated prediction advertisement selection ratio is equal to or greater than the threshold value, the specific recipient group is determined as the trustee group for the second advertisement.

Here, the result the prediction advertisement selection ratio calculated for the second advertisement is equal to or greater than the threshold value means that the probability of selecting the advertisement is high when the second advertisement is received in the specific recipient group in the future (for example, a next period), so that the specific recipient group may be determined as the trustee group that guarantees the advertising effect on the second advertisement based on the result,

Meanwhile, in the case of the second advertisement, it is mentioned that each of the plurality of advertisements received in the specific recipient group refers to each advertisement other than the first advertisement which is verified that the advertisement selection ratio is equal to or greater than the threshold value (or the largest).

Accordingly, there are many second advertisements. For each of the second advertisements, it is also performed a similarity determination process with the first advertisement, a prediction advertisement selection ratio calculation process, and a process of verifying whether the calculated prediction advertisement selection ratio is equal to or greater than a threshold value.

As a result, a second advertisement having a prediction advertisement selection ratio equal to or higher than a threshold value in the specific recipient group may also be in plural. In this case, the specific recipient group may be determined as the trustee group for each second advertisement.

The providing unit 65 performs the function of providing the bidding information.

More specifically, when the trustee group is determined, the providing unit 35 may provide advertisers with information with respect to the determined trustee group as the bidding information, thereby inducing the advertisers to actively participate in the bidding.

For reference, the trustee group that guarantees the advertising effect for the second advertisement is determined through the similarity determination between advertisements and the prediction advertisement selection ratio calculation process, it may set a high advertisement fee for the opportunity to provide the second advertisement for the trustee group.

On the other hand, there may be a plurality of second advertisements having a prediction advertisement selection ratio equal to or higher than the threshold value in the specific recipient group. In this case, it has been mentioned that the specific recipient group may be determined as the trustee group for each second advertisement.

Here, when there are the plurality of second advertisements having the prediction advertisement selection ratio equal to or greater than the threshold value, a size of the calculated prediction advertisement selection ratio for each second advertisement may be different. When the size of the prediction advertisement selection ratio is different, it may be expected that the advertising effect guaranteed for each second advertisement in the trustee group is also different.

As a result, the trustee group determined for each second advertisement is common to the specific recipient group but the advertising effect guaranteed for each second advertisement is different, so that the advertisement fee for providing each second advertisement may also be differently set according to the size priority of the calculated prediction advertisement selection ratio.

In each of the above described configurations of the advertisement bidding device 60, it has been mentioned that a software module executed by a processor, a hardware module, or a combination thereof may be implemented.

As such, the software module executed by the processor, the hardware module, or a combination thereof may be implemented in a hardware system (for example, a computer system).

As described above, in accordance with the advertisement bidding device 60 according to the second embodiment of the present disclosure, the advertisers may be expected to actively participate in the bidding by determining the trustee group that guarantees the advertising effect among the recipients which received the advertisement and providing the information with respect to the determined trustee group to the advertisers as the bidding information.

In addition, the trustee group determination process according to the second embodiment of the present disclosure is periodically performed after the advertisement of the advertiser is registered, and thus, the trustee group for the registered advertisement is changed or maintained so that it is possible to maximally guarantee the advertising effect desired by the advertisers.

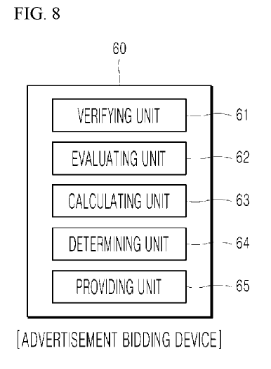

Hereinafter, an operation flow in the advertisement bidding device 60 according to the second embodiment of the present disclosure will be described with reference to FIG. 9. For convenience of a description, the above described the configurations shown in FIGS. 7 and 8 are described by referring to corresponding reference numbers.

Firstly, the verifying unit 61 verified an advertisement selection ratio for each of a plurality of advertisements received in a specific recipient group in Operation S21.

Here, the advertisement selection ratio refers to a ratio between the number of times of reception of the advertisement that is received in the specific recipient group and the number of times of selection of the advertisement that is selected in the specific recipient group for each advertisement.

At this point, the verifying unit 61 verifies the advertisement selection ratio for a specific period for each advertisement received in the specific recipient group, and the specific period may correspond to a period (for example, one week and one day) until a specified period for determining a trustee group arrives.

For reference, a high advertisement selection ratio for a specific advertisement may mean that the advertising effect is high in the specific recipient group, and contrarily, a low advertisement selection ratio may mean that the advertising effect is low in the particular recipient group.

Then, when the advertisement selection ratio for each advertisement received in the specific recipient group is verified, the evaluating unit 62 evaluates similarity between a first advertisement which is verified that the advertisement selection ratio is equal to or greater than a threshold value (or the largest) and a second advertisement which is the remaining advertisement received in the specific recipient group excluding the first advertisement in Operation S22.

Here, the similarity between the first advertisement and the second advertisement may be determined through a method of verifying a recipient which selects the first advertisement and the second advertisement in the specific recipient group.

Accordingly, the evaluating unit 62 evaluates the similarity between the first advertisement and the second advertisement by verifying the ratio of the recipients selecting both the first advertisement and the second advertisement in the specific recipient group.

At this time, the evaluating unit 62 evaluates that the similarity between the first advertisement and the second advertisement is high if the ratio of the recipients selecting both the first advertisement and the second advertisement increases, and contrarily, it evaluates that the similarity between the first advertisement and the second advertisement is low if the ratio of the recipients selecting both the first advertisement and the second advertisement decreases

Here, the result that the ratio of the recipients selecting both the first advertisement and the second advertisement in the specific recipient group is large indicates that the recipient selecting the first advertisement selects the second advertisement, and contrarily, the recipients of the second advertisement also has a higher probability of selecting the first advertisement, so that the similarity between the first advertisement and the second advertisement may be determined to be high based on the result.

Next, when the determination of the similarity between the first advertisement and the second advertisement is completed, the calculating unit 63 calculates the prediction advertisement selection ratio for the second advertisement based on the similarity determined between the first advertisement and the second advertisement and the advertisement selection ratio substantially verified for the second advertisement in Operation S23.

Here, the prediction advertisement selection ratio refers to the advertisement selection ratio predicted in the future (for example, a next cycle) for the second advertisement, and it may be calculated by a method of multiplying the similarity determined between the first advertisement and the second advertisement and the substantially verified advertisement selection ratio for the second advertisement.

At this point, in calculating the prediction advertisement selection ratio for the second advertisement, the calculating unit 63 calculates a ratio that does not exceed the substantially verified advertisement selection ratio for the second advertisement, and for this, the similarity value determined for the first advertisement and the second advertisement is leveled to a value between 0 and 1, and is multiplied by the advertisement selection ratio verified for the second advertisement.

Further, when the prediction advertisement selection ratio for the second advertisement is calculated, the determining unit 64 determines whether the calculated prediction advertisement selection ratio is equal to or greater than the threshold value, and, when the calculated prediction advertisement selection ratio is equal to or greater than the threshold value, it determines the specific recipient group as the trustee group for the second advertisement in Operations S24 and S25.

Here, if the result that the prediction advertisement selection ratio calculated for the second advertisement is equal to or greater than the threshold value, when the second advertisement is received in the specific recipient group in the future (for example, a next period), it means that there is a high probability of selecting the advertisement, so that the specific recipient group may be determined as the trustee group that guarantees the advertising effect for the second advertisement based on the result.

Meanwhile, in the case of the second advertisement, it has been mentioned that each of the plurality of advertisements received in the specific recipient group refers to each advertisement other than the first advertisement which is verified that the advertisement selection ratio is equal to or greater than the threshold value (or the largest).

Accordingly, there are many second advertisements. For each of the second advertisements, it may also be performed the similarity determination process with respect to the first advertisement, a prediction advertisement selection ratio calculation process, and a process of verifying whether the calculated prediction advertisement selection ratio is equal to or greater than the threshold value.

As a result, the second advertisement having a prediction advertisement selection ratio equal to or higher than a threshold value in the specific recipient group may also be in plural. In this case, the specific recipient group may be determined as the trustee group for each second advertisement.

Then, when the trustee group is determined, the providing unit 35 provides the advertisers with information with respect to the determined trustee group as the bidding information, thereby inducing active participation of the advertisers in the bidding in Operation S26.

For reference, the trustee group that guarantees the advertising effect on the second advertisement is determined through the determination of the similarity between advertisements and the calculation process of the prediction advertisement selection ratio, so that it may be set the advertisement fee for the opportunity to provide the second advertisement for the trustee group to be high.

Meanwhile, there may be a plurality of second advertisements having the prediction advertisement selection ratio equal to or higher than the threshold value in the specific recipient group, and in this case, it has been mentioned that the specific recipient group may be determined as the trustee group with respect to each second advertisement.

Here, when there is a plurality of second advertisements having the prediction advertisement selection ratio equal to or greater than the threshold value, the calculated prediction advertisement selection ratio for each second advertisement may be different. When a size of the prediction advertisement selection ratio is different, it may be expected that the advertising effect guaranteed for each second advertisement in the trustee group is also different.

As a result, the trustee group determined for each second advertisement is common to the specific recipient group, but the advertising effect guaranteed for each second advertisement is different, so that the advertisement fee for providing each second advertisement may also be set differently according to the size priority of the calculated prediction advertisement selection ratio.

As described above, according to the operation flow in the advertisement bidding device 60 according to the second embodiment of the present disclosure, the advertisers may be expected to actively participate in the bidding by determining the trustee group that guarantees the advertising effect among the recipients which receive the advertisements and providing the information with respect to the determined trustee group to the advertisers as the bidding information.

In addition, the trustee group determination process according to the second embodiment of the present disclosure is periodically performed after the advertisement of the advertiser is registered. Thus, it is possible to maximally guarantee the advertising effect desired by advertisers by changing or maintaining the trustee group for the registered advertisement,

Hereinafter, a third embodiment of the present disclosure will be described with reference to the accompanying drawings.

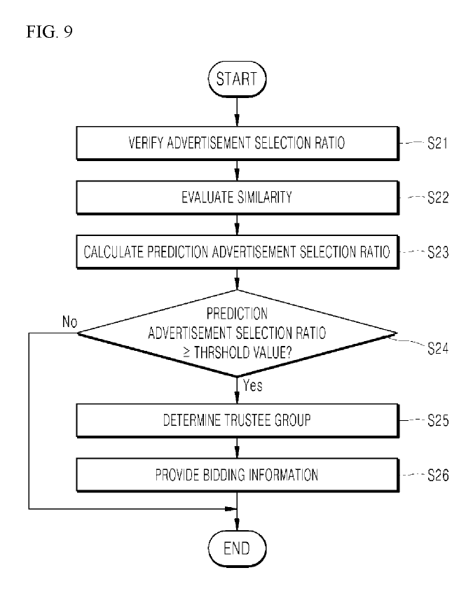

FIG. 10 is a diagram illustrating an advertisement providing system according to a third embodiment of the present disclosure.

As shown in FIG. 10, the advertisement providing system according to the third embodiment of the present disclosure has configuration including a terminal device 100 for receiving an advertisement and an advertisement platform device 200 for providing an advertisement to the terminal device 100.

The terminal device 100 refers to a mobile device capable of receiving the advertisement through an advertisement medium.

For example, the terminal device 100 may be a smart phone, a tablet PC, a PDA, and the like, and is capable of receiving an advertisement through the advertisement medium, which is not limited thereto, and all devices capable of running a browser for connecting to a service page (for example, a web page).

Here, the advertisement medium, which enables advertisement reception in the terminal device 100, may be, for example, an application executed in the terminal device 100 itself or a service page (for example, a web page) in which the terminal device 100 may access the browser by calling the browser.

In such an advertisement medium, an SDK related to receiving advertisements is included in the development process. As a result, the terminal device 100 performs a series of operations for requesting, receiving, and displaying the advertisements through the SDK included in the advertisement medium.

In addition, the advertisement medium may support not only the above described a series of functions, which is followed by advertisement request, reception and display, but also an information transfer function that transmits log information related to an advertisement to the advertisement platform device 200.

Accordingly, in the terminal device 100, various log information including terminal related information (for example, a resolution, a mobile service provider, a network type, terminal identification information), advertisement medium related information (for example, advertisement medium identification information), time related information (an advertisement request time, an advertisement display time, and advertisement selection time), and advertisement related information (for example, whether an advertisement is received, whether an advertisement is displayed, whether an advertisement is selected) may be transmitted to the advertisement platform device 200 through an advertisement medium.

Meanwhile, in the terminal device 100 according to the third embodiment of present disclosure, an advertisement is received through a pull method, which is a method of requesting and receiving the advertisement to and from the advertisement platform device 200.

However, it is not limited to the above described advertisement receiving method, and it may also be possible that the advertisement may be received by a push method for receiving an advertisement provided by the advertisement platform device 200 without a separate advertisement request for the advertisement platform device 200.

The advertisement platform device 200 refers to an advertisement server that provides the advertisement to the terminal device 100.

In the advertisement platform device 200, when the advertisement is requested from the terminal device 100, the advertisement having a high probability of being selected in the terminal device 100 is selected, and a selected advertisement is provided to the terminal device 100, so that the advertising effect is guaranteed.

Meanwhile, in the advertisement platform device 200 according to the third embodiment of the present disclosure, an operation of selecting an advertiser capable of registering an advertisement is performed prior to the above described operation of providing an advertisement to the terminal device 100.

For this purpose, the advertisement platform device 200 follows a bidding method of selecting an advertiser that may register an advertisement in the advertisement platform device 200 among a plurality of advertisers participating in the bidding.

Competition for attracting the advertisers from other advertising agencies is inevitable.

In order to gain a competitive advantage in attracting the advertisers between advertising agencies, it may be expected that the desired advertising effect should be guaranteed, and there is a need to provide in advance bidding information related to the advertising effect guarantee to the advertisers participating in the bidding.

Accordingly, in the third embodiment of the present disclosure, a method for predicting the number of times of selection of the advertisement (for example, CTR, click to ratio) at the terminal device 100 and providing predicted results to the advertisers as the bidding information is proposed. Hereinafter, the advertisement platform device 200 for implementing the method will be described in detail.

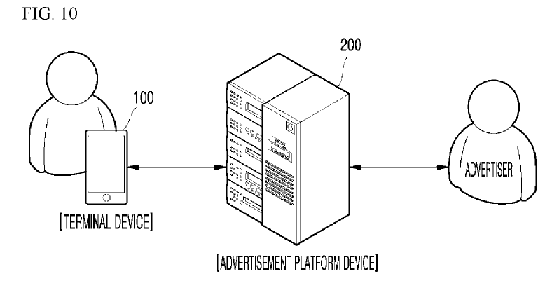

FIG. 11 shows a configuration of the advertisement platform device 200 according to the third embodiment of the present disclosure.

As shown in FIG. 11, the advertisement platform device 200 according to the third embodiment of the present disclosure includes a providing unit 81 for providing an advertisement to the terminal device 100, a determining unit 82 for determining log information (hereinafter, referred to as prediction log information) for predicting the number of times of selection of the advertisement, a classifying unit 83 for classifying the prediction log information, a predicting unit 84 for predicting the number of times of selection of the advertisement that is selected using the classified prediction log information, and a bidding unit 85 for providing advertisers with bidding information of the number of times of selection of the advertisement.

All or at least a portion of the advertisement platform device 200 including the providing unit 81, determining unit 82, the classifying unit 83, the predicting unit 84, and the bidding unit 85, which are described above, may be implemented in the form of a software module executed by a processor, a hardware module form, or a combination thereof.

As a result, in the case of the advertisement platform device 200 according to the third embodiment of the present disclosure, the number of advertisement selection is predicted through the above configurations, and the predicted results are provided to the advertisers as the bidding information. Hereinafter, each configuration in the advertisement platform device 200 for implementing the operations will be described in detail.

The providing unit 81 performs the function of providing an advertisement.

More specifically, the providing unit 81 provides the advertisement to the terminal device 100 when an advertisement request is received from the terminal device 100.

At this point, the providing unit 81 may receive log information including, for example, terminal related information (for example, resolution, mobile communication company, network type, terminal identification information), advertisement medium related information (for example, advertisement medium identification information), time related information (for example, an advertisement request time), and whether to agree to use personal information together with an advertisement request from the terminal device 100.

Further, after providing the advertisement to the terminal device 100, when the advertisement is received, displayed, and selected at the terminal device 100, the providing unit 81 additionally receives various log information including, for example, terminal related information (for example, a resolution, a mobile service provider, a network type, terminal identification information), advertisement medium related information (for example advertisement medium identification information), time related information (for example, an advertisement display time and advertisement selection time), and advertisement related information (for example, whether to receive an advertisement, whether to display an advertisement, and whether to select an advertisement).

The determining unit 82 performs the function of determining prediction log information.

More specifically, the determining unit 82 determines prediction log information for predicting the number of times of selection of other advertisements in the log information received in association with the advertisement from the terminal device 100 for a predetermined period corresponding to a specific period, for example.

Here, the other advertisement is an advertisement classified into the same advertisement classification item (for example, a category) as the advertisement provided to the terminal device 100, and, to predict the number of other advertisements having the same advertisement classification item as that of the advertisement provided to the terminal device 100, it is intended to guarantee the reliability with respect to the number of times of selection of the other advertisements, which is finally predicted based on the identity of the advertisement classification item between the advertisement provided to the terminal device 100 and other advertisement in which selection frequency is predicted.

At this point, the determining unit 82 may determine the prediction log information by verifying the log information correlated with the number of times of selection of the advertisement among the log information that is received from the terminal device 100.

Here, in the case of the number of times of selections of the advertisement, it may be expanded and interpreted to an advertisement selectivity (CTR). In order to expand and interpret advertisement selectivity by the selection ratio of the advertisement, it is necessary that a ratio between the number of times of reception of the advertisement, which indicates the advertisement selection ratio in the terminal device 100, and the number of times of selection of the advertisement should be verified.

Meanwhile, the determining unit 82 may determine the prediction log information through, for example, a regression analysis method. That is, each of the received log information related to the advertisement is set as an independent variable of the X axis and the number of advertisement selection as a dependent variable of the Y axis, so that it is possible to determine the log information corresponding to the independent variable as the prediction log information by finding the independent variable which has a large influence on the change of the dependent variable.

As a result, the correlation between the number of times of selection of the advertisement and the log information indicates that there is a linear relationship between the number of times of selection of the advertisement and the log information by the regression analysis method, and a magnitude of the correlation may correspond to the result of a regression equation representing the linear relationship.

The presence of the correlation between the number of times of selection of the advertisement and the log information means that the log information has a greater influence on the number of times of selection of the advertisement than the other log information as a result of establishing the linear relationship with the number of times selections of the advertisement, so that it can be seen that the log information determined as the prediction log information has a higher reliability as a reference for predicting the selection frequency of other advertisements.

On the other hand, the correlation with the number of times selections of the advertisement for each log information may be temporarily verified only during a specific period, and this may adversely affect the reliability of the prediction log information as a criterion for predicting the number of selections of other advertisements.

Therefore, the determining unit 82 does not determine the log information that is determined to have a correlation during the current period as the unconditional prediction log information, but only the log information in which the difference from the magnitude of the correlation detected during the previous period is less than the threshold value is determined as the prediction log information.

That is, in the third embodiment of the present disclosure, the prediction log information is determined only for the log information in which the magnitude of the correlation with the number of time of selections of the advertisement is continuously maintained, so that it is expected an effect in which the reliability of prediction log information may be greatly improved.

The classifying unit 83 performs the function of classifying the prediction log information.

More specifically, when the prediction log information is determined, the classifying unit 83 classifies the prediction log information into prediction log information (hereinafter, referred to as first prediction log information) having an attribute mapped to a numerical value and prediction log information (hereinafter, referred to as second prediction log information) having an attribute not mapped to a numerical value.

Here, the first predication log information is the log information that is expressed as numerical values (for example, once, twice, and three times) such as the number of times of reception of the advertisement, the number of times the advertisement is displayed, the number of times of selection of the advertisement, and the like. On the other hand, the second predication log information is the log information, for example, in which the attribute (for example, application or a web page) cannot be expressed numerically, such as the type of an advertisement medium for which the advertisement is requested.

As such, the reason for classifying the prediction log information into the first prediction log information and the second prediction log information is that the mapping of a specific value to the attribute value of the second predication log information having an attribute that is not mapped to the numerical value as described above for the prediction result of the number of times of selection of the other advertisement to which the quantized result value should be derived.

It is needless to say that the process of classifying the prediction log information may be omitted if all the log information determined by the prediction log information may be determined only by the first prediction log information having the mapped attribute.

The predicting unit 84 serves to predict the number of times of selection of the advertisement.

More specifically, when the predicting unit 84 classifies the prediction log information into the first prediction log information and the second prediction log information, the predicting unit 84 predicts the number of times of selection of the advertisement based on based on the value mapped to the first prediction log information and the value mapped to the second prediction log information.

Here, in the case of the second predication log information, as described above, the attribute is not mapped to the numerical value. In order to calculate the preference, a process of mapping a specific value to the attribute value of the second predication log information should be preceded.

The predicting unit 84 maps a specific value to an attribute value of the second prediction log information using the log information related to at least a part of the advertisement in which the second prediction log information having the same attribute value is verified among the log information received from the terminal device 100 in relation to a plurality of advertisements.

Here, the result that the second predication log information having the same attribute value is verified may be interpreted as there is a minimum similarity between the advertisements, and thus since the specific value is mapped to the attribute value of the second prediction log information using the log information having the similarity between the advertisements, so that the reliability of the mapped specific value may also be guaranteed.

As a result, the predicting unit 84 verifies the values mapped to the first preference log information in the log information of the advertisements for which the second predication log information having the same attribute value is verified, and thus the average value of the verified values is mapped to the attribute value of the second predication log information.

For example, it will be assumed and described that the first predication log information is the number of times the advertisement is displayed having an attribute mapped to a numerical value, the second predication log information is an advertisement medium type having an attribute that is not mapped to a numerical value, and the terminal device 100 requests an advertisement through one of the advertisement medium types.

In this case, the predicting unit 84 may select the advertisement requested through the application from the log information received from the terminal device 100 in association with a plurality of advertisements, and may map a specific value to an attribute value (application) of the advertisement medium type, which is the second predication log information, using the received log information with respect to the selected advertisement.

That is, the predicting unit 84 may verify all the number of times the advertisement is displayed, which is the first prediction log information in the log information related to the selected advertisement, and derive an average value of the number of times the advertisement is displayed, thereby mapping a specific numerical value to the attribute value (application) of the advertisement medium type.

When a plurality of first prediction log information are classified as the prediction log information, the predicting unit 84 maps the specific value to the attribute value of the second prediction log information by referring to the log information that the magnitude of the correlation is verified to be the largest among the correlations. The reason for that is that this is also to increase the reliability with respect to in the specific value being mapped.

Further, when the specific value is mapped to the attribute value of the second predication log information, the predicting unit 84 predicts the number of times of selection of the other advertisement based on the numerical value mapped to the first prediction log information and the numerical value mapped to the second prediction information.

At this point, the predicting unit 84 assigns the magnitude of the correlation (for example, the result value of the regression equation) to each of the values mapped to the first prediction log information and the second prediction log information as a weight, so that the result values may be finally predicted as the number of times of selection of the other advertisement as in Equation 5.

Preference=Correlation(σ)×values mapped to first prediction log information+correlation(β)×specific values mapped to first prediction log information [Equation 5]

The bidding unit 85 performs a function of providing the bidding information.

More specifically, when the number of times of selection of the other advertisement is predicted, the bidding unit 85 provides predicted results to the advertisers as the bidding information related to the other advertisement, thereby inducing advertisers' active participation in an advertisement registration in the advertisement classification item to which the other advertisement belongs.

As described above, in accordance with the advertisement platform device 200 according to the third embodiment of the present disclosure, the number of time of selections (CTR) with respect to advertisements is predicted and provided to the advertisers as the bidding information, so that it may be expected that the advertisers participate actively in the bidding.

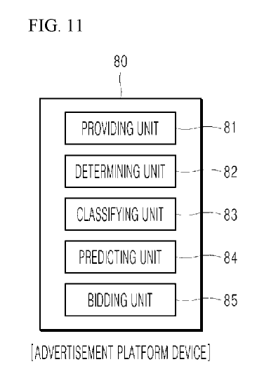

Hereinafter, an operation flow in the advertisement platform device 200 according to the third embodiment of the present disclosure will be described with reference to FIG. 12. For convenience of a description, the configurations shown in FIGS. 11 to 13 will be described with reference to corresponding reference numbers.

Firstly, the providing unit 81 provides an advertisement to the terminal device 100 when an advertisement request is received from the terminal device 100 in Operations S31 and S32.

At this point, the providing unit 81 may receive log information including, for example, terminal related information (for example, a resolution, a mobile service provider, a network type, terminal identification information), advertisement medium related information (for example, advertisement medium identification information), time related information (for example, an advertisement request time), and whether to agree to use personal information together with the advertisement request received from the terminal device 100 in Operation S31.

Further, after providing the advertisement to the terminal device 100, when the advertisement is received, displayed, and selected at the terminal device 100, the providing unit 81 additionally receives various log information including, for example, terminal related information (for example, a resolution, a mobile service provider, a network type, terminal identification information), advertisement medium related information (for example advertisement medium identification information), time related information (for example, an advertisement display time and advertisement selection time), and advertisement related information (for example, whether to receive an advertisement, whether to display an advertisement, and whether to select an advertisement) in Operation S33.

Then, the determining unit 82 determines prediction log information for predicting the number of times of selection of the other advertisement among the log information received in association with the advertisement from the terminal device 100 for a predetermined period corresponding to a specific period in Operation S34.

At this point, the determining unit 82 may determine the prediction log information by verifying the log information correlated with the number of times of selection of the advertisement among the log information received from the terminal device 100.

In this regard, the determining unit 82 may determine the prediction log information through, for example, a regression analysis method. That is, each of the received log information related to the advertisement is set as an independent variable of an X axis and the number of times of selection of the advertisement as a dependent variable of a Y axis, so that it is possible to determine the log information corresponding to the independent variable as the prediction log information by finding the independent variable which has a large influence on the change of the dependent variable.

On the other hand, the correlation with the number of times of selection of the advertisement for each log information may be temporarily verified only during a specific period, and this may adversely affect the reliability of the prediction log information as a criterion for predicting the number of selections of other advertisements.

Therefore, the determining unit 82 does not determine the log information that is determined to have a correlation during the current period as the unconditional prediction log information, but only the log information in which the difference from the magnitude of the correlation detected during the previous period is less than the threshold value is determined as the prediction log information.

That is, in the third embodiment of the present disclosure, the prediction log information is determined only for the log information in which the magnitude of the correlation with the number of time of selections of the advertisement is continuously maintained, so that it is expected an effect in which the reliability of prediction log information may be greatly improved.

Thereafter, when the prediction log information is determined, the classifying unit 83 classifies the prediction log information into first prediction log information having an attribute mapped to a numerical value and second prediction log information having an attribute not mapped to a numerical value in Operation S35.

As such, the reason for classifying the prediction log information into the first prediction log information and the second prediction log information is that the mapping of a specific value to the attribute value of the second predication log information having an attribute that is not mapped to the numerical value as described above for the prediction result of the number of times of selection of the other advertisement to which the quantized result value should be derived.

It is needless to say that the process of classifying the prediction log information may be omitted if all the log information determined by the prediction log information may be determined only by the first prediction log information having the mapped attribute.

Afterward, when the classification of the prediction log information into the first prediction log information and the second prediction log information is completed, the predicting unit 84 predicts the number of times of selection of the other advertisement based on based on the value mapped to the first prediction log information and the value mapped to the second prediction log information in Operations S36 and S37.

Here, in the case of the second predication log information, as described above, the attribute is not mapped to the numerical value. In order to calculate the preference, a process of mapping a specific value to the attribute value of the second predication log information should be preceded.

The predicting unit 84 maps a specific value to an attribute value of the second prediction log information using the log information related to at least a part of the advertisement in which the second prediction log information having the same attribute value is verified among the log information received from the terminal device 100 in relation to a plurality of advertisements in Operation S36.

Here, the result that the second predication log information having the same attribute value is verified may be interpreted as there is a minimum similarity between the advertisements, and thus since the specific value is mapped to the attribute value of the second prediction log information using the log information having the similarity between the advertisements, so that the reliability of the mapped specific value may also be guaranteed.

As a result, the predicting unit 84 verifies the values mapped to the first preference log information in the log information of the advertisements for which the second predication log information having the same attribute value is verified, and thus the average value of the verified values is mapped to the attribute value of the second predication log information.

Further, when the specific value is mapped to the attribute value of the second predication log information, the predicting unit 84 predicts the number of times of selection of the other advertisement based on the numerical value mapped to the first prediction log information and the numerical value mapped to the second prediction log information in Operation S37.

At this point, the predicting unit 84 assigns the magnitude of the correlation (for example, the result value of the regression equation) to each of the values mapped to the first prediction log information and the second prediction log information as a weight, so that the result values may be finally predicted as the number of times of selection of the other advertisement.

Next, when the number of times of selection of the other advertisement is predicted, the bidding unit 85 provides predicted results to the advertisers as the bidding information related to the other advertisement, thereby inducing advertisers' active participation in an advertisement registration in the advertisement classification item to which the other advertisement belongs.

As described above, in accordance with the operation flow of the advertisement platform device 200 according to the third embodiment of the present disclosure, the number of time of selections (CTR) with respect to advertisements is predicted and provided to the advertisers as the bidding information, so that it may be expected that the advertisers participates actively in the bidding.

The functional operations and implementations of the subject matter described herein may be implemented as digital electronic circuitry, or may be implemented in computer software, firmware, hardware, including the structures disclosed herein and structural equivalents thereof, or one or more combinations thereof. Implementations of the subject matter described herein may be implemented in one or more computer program products, in other words, one or more modules of computer program instructions encoded on a tangible program storage medium to control operation of a processing system or to be executed by the processing system

The computer-readable medium may be a machine-readable storage device, a machine-readable storage substrate, a memory device, a composition of material that affects the machine-readable radio wave type signal, or one or more combinations thereof

As used herein, “system” or “device” includes all kinds of apparatuses and machines for processing data including, for example, a programmable processor, a computer, a multiprocessor, or a computer. In addition to the hardware, the processing system may include, for example, a code configuring processor firmware, and a code configuring an execution environment for the computer program upon request of, for example, a protocol stack, a database management system, an operating system, or one or more combinations thereof, or the like

A computer program (also known as a program, software, a software application, a script or a code) may be written in any form of a programming language including a compiled or interpreted language, or a priori or procedural language, and may be deployed in any form including independent programs or modules, components, subroutines, or other units suitable for use in a computer environment. The computer program may not necessarily correspond to a file in a file system. The program may be stored in a single file provided to the requested program, in multiple interactive files (for example, a file storing one or more modules, subprograms or portions of a code), or in a part of a file (for example, one or more scripts stored in a markup language document) containing other programs or data. The computer program may be located on one site or distributed across multiple sites such that it is deployed to run on multiple computers interconnected by a communications network or on one computer.

The computer readable media suitable for storing computer program instructions and data may include, for example, semiconductor memory devices such as an EPROM, an EEPROM and flash memory devices, all sort of non-volatile memories including magnetic disks such as internal hard disks or external disks, magnetic optical discs and CD-ROM and DVD-ROM disks, a media, and memory devices. A processor and a memory may be supplemented by special purpose logic circuits or integrated therewith.

Implementations of the subject matter described herein may be realized on an arithmetic system including, for example, a back-end component such as a data server, a middleware component such as an application server, a front-end component such as a client computer with a web browser or a graphical user interface allowing a user to interact with the implementations of the subject matter described herein, or one or more combinations of the back-end component, the middleware component, and the front-end component. The components of the system may be interconnected by any form or medium of digital data communications such as, for example, a communication network.

While the present disclosure includes a number of specific implementation details, they are not to be construed as limitations on any invention or the claimable scope. Rather, it should be understood as a description of features that may be specific to a particular embodiment of a particular invention. Similarly, the specific features described herein in the context of individual embodiments may be implemented in combination in a single embodiment. Alternatively, various features described in the context of a single embodiment may also be implemented in multiple embodiments individually or in any suitable sub-combination. Further, although the features may be described as operating in a particular combination and initially claimed as such, one or more features from the claimed combination may in some cases be excluded from the combination, and the claimed combination may be altered to a variant of a sub-combination or sub-combination.

Also, while the present disclosure illustrates operations in the drawings in a particular order, it should not be understood that such operations must be performed in that particular order or sequential order shown in the drawings in order to obtain a desired result, or that all illustrated operations should be performed. In certain cases, multitasking and parallel processing may be advantageous. Also, the separation of the various system components of the above described embodiments should not be understood as requiring such separation in all embodiments, and it should be understood that the program components and systems described above may generally be integrated together into a single software product or packaged into multiple software products.

As such, the present disclosure is not intended to limit the inventions to the specific terms disclosed herein. Thus, although the present disclosure has been described in detail with reference to the above examples, those skilled in the art would conceive alternations, modifications, and deformations on these examples without departing from the scope of the present disclosure. The scope of the present disclosure is defined by the appended claims rather than the description, and it should be construed that all alternations and modifications derived from the meaning and scope of the appended claims and their equivalents are included within the scope of the present disclosure.

1. An advertisement bidding device comprising:
a verifying unit configured to verify a first recipient group in which preference for an advertisement is equal to or greater than a threshold value and a second recipient group in which preference for the advertisement is equal to or less than the threshold value among recipients receiving the advertisement;
an evaluating unit configured to evaluate reliability of the preference calculation criteria for calculating the preference based on a reaction state of the advertisement in the first recipient group and the second recipient group; and
a determining unit configured to determine the first recipient group as a trustee group receiving the advertisement when the reliability of the preference calculation criteria is determined to be equal to or greater than a threshold value.

2. The advertisement bidding device of claim 1, wherein the reaction state with respect to the advertisement is verified from a first selection ratio that is a ratio of the recipients which select the advertisement in the first recipient group and a second selection ratio that is a ratio of the recipients which select the advertisement in the second recipient group.

3. The advertisement bidding device of claim 2, wherein the reliability of the preference calculation criteria is evaluated to be higher as the first selection ratio is greater than the second selection ratio.

4. The advertisement bidding device of claim 3, wherein the reliability of the preference calculation criteria is evaluated to be higher as a difference between the number of recipients belonging to the first recipient group and the number of recipients belonging to the second recipient group is smaller.

5. The advertisement bidding device of claim 1, further comprising:
a changing unit configured to change the preference calculation criteria when the reliability of the preference calculation criteria is determined to be less than the threshold value.

6. An advertisement bidding device comprising:
an evaluating unit configured to evaluate a similarity between a first advertisement having an advertisement selection ratio equal to or higher than a threshold value among a plurality of advertisements received in a specific recipient group and a second advertisement being one of the remaining advertisements excluding the first advertisement;
a calculating unit configured to calculate a prediction advertisement selection ratio with respect to the second advertisement based on the similarity evaluated for the second advertisement and the advertisement selection ratio of the second advertisement; and
a determining unit configured to determine the specific recipient group as the trustee group with respect to the second advertisement when the prediction advertisement selection ratio with respect to the second advertisement is equal to or greater than a threshold value.

7. The advertisement bidding device of claim 6, wherein the similarity is evaluated based on a ratio of the recipients which select both the first advertisement and the second advertisement in the specific recipient group.

8. The advertisement bidding device of claim 7, wherein the evaluating unit evaluates the similarity to be higher as the ratio of recipients which select both the first advertisement and the second advertisement in the specific recipient group increases.

9. The advertisement bidding device of claim 6, wherein the advertisement selection ratio is a ratio between the number of times of reception of the advertisement that is received in the particular recipient group and the number of times of selection of the advertisement that is received in the particular recipient group during a specific time period.

10. The advertisement bidding device of claim 6, wherein the prediction advertisement selection ratio is determined as a multiplication between the similarity determined for the second advertisement and the advertisement selection ratio of the second advertisement within the advertisement selection ratio of the second advertisement through.

11. An advertisement platform device comprising:
a determining unit configured to determine log information which has a correlation with the number of times of selection of an advertisement among the log information received from a user in association with the advertisement as prediction log information for predicting the number of times of selection of other advertisements classified as the same advertisement classification item as the advertisement;
a classifying unit configured to classify the prediction log information into a first prediction log information having an attribute mapped to a numerical value and a second prediction log information having an attribute not mapped to the numerical value; and
a predicting unit configured to map a specific value to the second predication log information and predict the number of times of selection of the other advertisements with respect to a user based on the numerical value mapped to the first prediction log information and a specific value mapped to the second prediction log information.

12. The advertisement platform device of claim 11, wherein the specific value is mapped to the second prediction log information based on log information related to at least a portion of advertisements of which the second predication log information has the same attribute values among a plurality of advertisements when log information related to the plurality of advertisements are received from the user.

13. The advertisement platform device of claim 12, wherein the specific value is mapped to the second prediction log information as an average value of the numerical values mapped to the first predication log information existing in log information related to the at least a portion of advertisements.

14. The advertisement platform device of claim 13, wherein the specific value is mapped to the second prediction log information as an average value of the numerical values mapped to first specific prediction log information in which a magnitude of a correlation is equal to or greater than a threshold value among the first prediction log information equal to or greater than 2 when the first prediction log information is equal to or greater than 2.

15. The advertisement platform device of claim 11, wherein the number of times of selection of the other advertisements is predicted as result values by applying the magnitude of the correlation to the numerical values mapped to the first prediction log information and the specific values mapped to the second predication log information as a weight.
